(19) United States
(12) Patent Application Publication
(10) Pub. No.: US 2011/0236797 A1
(43) Pub. Date: Sep. 29, 2011

(54) MULTI-FUNCTIONAL TIGHTENING CLAMPS FOR A FUEL CELL

(75) Inventors: Valery Chaudron, Manosque (FR); Stephane Mazet, Pelissanne (FR); Christian Quintieri, Aix-En-Provence (FR); Lionel Vial, Istres (FR)

(73) Assignee: HELION, Aix En Provence Cedex 4 (FR)

(21) Appl. No.: 13/063,047

(22) PCT Filed: Sep. 15, 2009
(86) PCT No.: PCT/EP2009/061945

§ 371 Date: Jun. 7, 2011

(30) Foreign Application Priority Data
Sep. 17, 2008 (FR) 08 56254

(51) Int. Cl. H01M 8/02

(52) U.S. Cl. 429/509; 429/511

(57) ABSTRACT

The tightening clamps are multifunctional and ensure the transmission of the electric current generated by the fuel cell stack, the insulation of the different ducts and passage openings of the operation fluid of the fuel cell stack, and the tightening of the stack itself.

Each clamp comprises a single part, the upper surface and the side surfaces of which, except for the conductors, are coated with an insulating material. Similarly, the supply and discharge openings (23) are also insulated. However, the tightening surface (29) is at least coated with a conductive deposit on a predetermined area corresponding to the conducting areas of the upper surface of the end of the stack.

The invention can be used in PEM (“Proton Exchange Membrane”) fuel cells.

### FIELD OF THE INVENTION

The invention relates to the field of fuel cells whereof the industrial applications can be stationary or dedicated to transport.

The fixed or stationary applications for example relate to hospitals and other service buildings for which the possibility of an interruption in the electrical power supply must be eliminated. Applications relative to transportation concern, inter alia, the propulsion of urban public transportation vehicles, such as buses and subway trains.

### PRIOR ART AND TECHNICAL PROBLEM

The fuel cell is an electrochemical device that directly converts the chemical energy from a fuel into electrical energy. The operating principle of this electrochemical generator relies on the electrochemical synthesis reaction of water. Many fuel cells are made up of a succession of elementary stages also called electrochemical cells, each comprising a base element made up of two electrodes, an anode and a cathode, which continuously receive an oxidizer, e.g. air or oxygen, and a fuel, e.g. hydrogen, these two gaseous elements remaining separated by an ion exchange membrane serving as electrolyte. At the anode, the fuel undergoes a catalytic oxidation releasing protons and electrons, in the case of a fuel cell of the proton exchange membrane type. The electrons generated circulate along the exterior electrical circuit, while the protons are transported from the electrolyte towards the cathode, where they combine with the electrons and the oxygen. This cathodic reduction is accompanied by a production of water and the establishment of a potential difference between the two electrodes.

Several type of fuel cells coexist and differ by the nature of their electrolyte and their operating temperatures. Regarding fuel cells operating at “low” temperatures (temperatures below 100° C.), the most advanced technology is embodied by polymer electrolyte fuel cells. The invention developed here uses a PEM (Proton Exchange Membrane) fuel cell whereof the polymer electrolyte is a proton exchange membrane.

The core of a fuel cell is made up of an assembly of elementary electrochemical cells, stacked on each other in a sufficient number, in order to obtain the desired voltage and current values.

Such a stack of elementary cells of a fuel cell core is commonly called a “stack.”

In FIG. 1, each elementary cell of a PEM fuel cell is made up of two separating plates 1, ensuring the contribution of reactive gases and arranged on either side of an electrode/membrane/electrode assembly 2, called “EME.” The latter comprises an ion exchange electrolytic membrane 3 and two gas diffusion catalytic electrodes, i.e. an anode 4 and a cathode 5, each made up of an active layer 4A and 5A and a diffusion layer 4B and 4B. At the anode 4, after diffusion through the diffusion layer 4B, the hydrogen is catalytically oxidized in the active layer 4A to yield protons and electrons. The electrons take an exterior electric circuit towards the cathode 5, while the electrolytic membrane 3 ensures the transport of the protons from the anode 4 towards the cathode 5, but also the separation of the reactive gases. At the cathode 5, the oxygen therefore undergoes a catalytic reduction and recombines with the protons and the electrons to yield water.

In the stack of elementary cells, of a PEM-type fuel cell, the polar or bipolar plates 1 also perform the functions of distribution of the reactive gases, i.e. the oxygen from the air and the hydrogen, heat conduction, collection of the generated electrons, and discharge of the products of the reaction, including the water. Each polar or bipolar plate is in contact via one of its faces with an anode 4 of an EME assembly 2 with rank N, and on the other face with a cathode 5 of an assembly with rank N+1.

Moreover, on each polar or bipolar plate 1 are gas circulation channels 6 and cooling fluid circulation channels 7.

It is then necessary to mechanically assemble the assembly of all of these elements making up the stack of the fuel cell, including the polar or bipolar plates 1 and the EME assemblies 2.

As shown in FIG. 2, this assembly can require the implementation, on either side of the stack 10, of different elements, before the mechanical tightening of the stack 10. These elements are current collectors 11 performing the current collection function opposite the polar or bipolar plates, tightening clamps 12, electrically insulated or not, of the current collectors 11 placed at the ends of the stack 10, and extensions 13 making it possible to supply and discharge, from the stack 10, reactive gases, cooling liquid, and water generated by the electrochemical reaction. It is also necessary to ensure the insulation of the current collectors 11 and the clamps 12 relative to the reactive gases, which can be harmful for their component materials.

The tightening clamps 12, as well as the collectors 11, are pierced, in order to allow the insertion of extensions 13 up to the collectors machined in the polar or bipolar plates opposite the corresponding collector. Lastly, the tightening function of the stack is completed by the use of ties, which are inserted into openings machined in the clamps 12 and which are tightened to a predetermined torque, during the final assembly of the stack, according to the desired tightening stress.

Furthermore, in the case where the tightening clamps 12 do not perform the electrical insulation function, grommets make it possible to guarantee the electrical insulation between the ties (not shown) and the tightening clamps 12. Such a device then requires the assembly of several pieces each performing a specific function in the stack, inter alia: collection of the electrical current, electrical insulation, supply and discharge of reactive gases and cooling liquid, and tightening of the stack. This assembly of parts therefore has the drawback of complicating the design of the stack and the assembly and tightening thereof, by creating dimensional stresses.

The aim of the invention is therefore to resolve these drawbacks, by trying to simplify the assembly and tightening of the stack, in order to decrease the cost thereof and lighten the mechanical constraints generated by assembling the assembly of several parts together.

### BRIEF DESCRIPTION OF THE INVENTION

The inventive concept proposes to ensure that these last four listed functions, i.e. electrical conduction, electrical insulation, supply or discharge of the gases and cooling fluid, and mechanical tightening, are carried out by a single multifunctional part.

As a result, the main object of the invention is a single-unit tightening clamp for a fuel cell intended to ensure, via a tightening surface, the tightening of a stack of fuel cell elements whereof the end surface has both predetermined electrically conducting areas and predetermined electrically insulating areas.

According to the invention, the lower surface of the tightening clamp is covered with an insulating material over predetermined areas corresponding to the insulating areas of the end surface of the stack, and the surface of the tightening clamp is covered with a conducting material at the areas corresponding to the non-insulated areas of the end surface of the stack and the tightening clamp according to the invention is advantageously completed by supply openings covered with a material tolerating the use of the reactive gases used and water, and preferably electrically insulating.

In that case, it is preferable to provide connectors screwed into the supply openings.

Preferably, the electrically insulating material is a fluorinated resin and the electrically conducting material is silver.

### LIST OF FIGURES

The invention and its features will be better understood upon reading the following description, accompanied by several figures, which respectively show:

FIG. 1, already described, a diagram concerning the operation of the fuel cells;

FIG. 2, already described, in cross-section, an example of a stack of a fuel cell of the prior art;

FIG. 3, in isometric view, a fuel cell stack, using tightening clamps according to the invention;

FIG. 4, in isometric and top view, a tightening clamp according to the invention;

FIG. 5, in isometric and top view, the same tightening clamp according to the invention of FIG. 4, equipped with connectors; and

FIG. 6, in isometric and bottom view, the same tightening clamp according to the invention.

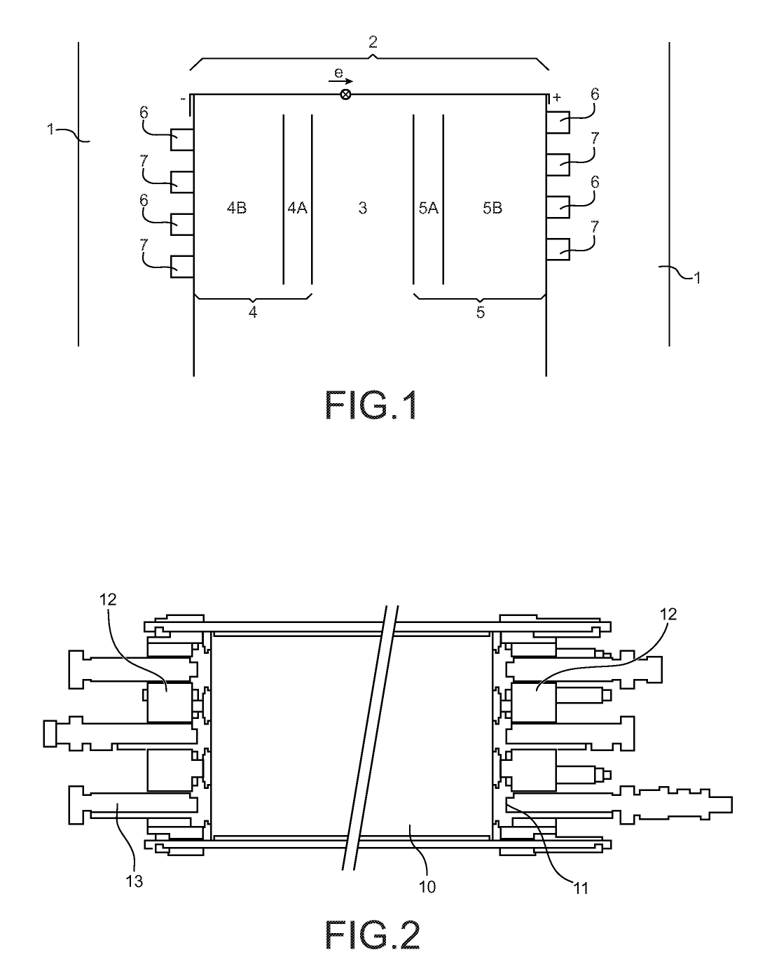

### DETAILED DESCRIPTION OF THE INVENTION

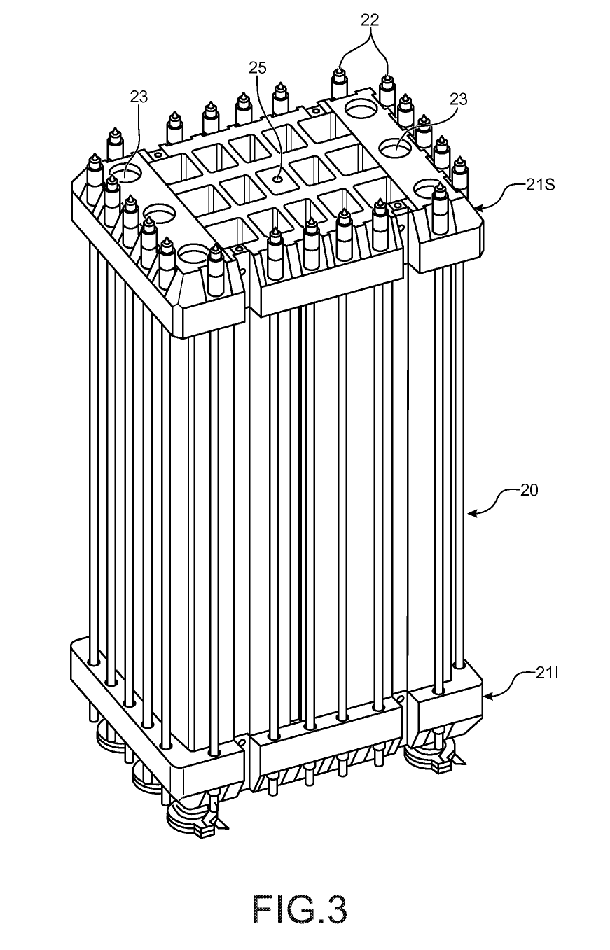

FIG. 3 makes it possible to understand the use of tightening plates according to the invention. Indeed, a fuel cell is shown. It primarily comprises a stack of elementary cells of a fuel cell on top of each other. This stack is kept tightened by a lower tightening clamp 21I and an upper tightening clamp 21S, these two lower 21I and upper 21S tightening clamps themselves being tightened by several ties 22, equipped with tightening means, in a normal manner. These two lower 21I and upper 21S clamps are single-piece, i.e. each made of a single piece.

The upper part of the upper tightening clamp 21S, and generally the entire surface area of the clamp that is not in contact with a separating plate, is covered with an electrically insulating material. The elements shown in this upper part of the upper tightening clamp 21S are supply and discharge openings 23 placed on two sides thereof and intended to supply and discharge the various operating fluids, i.e. the fuels, the water generated, and any cooling fluid, and a central conductor 25 for extracting the electricity generated in the stack 20.

The ties 22 can be equipped beforehand with dynamic washers, which make it possible to absorb part of the geometric changes of the stack. Indeed, even if the latter undergoes strong geometric variations, due, for example, to the heat expansion of the various materials of the stack, it only undergoes small variations in the stress applied during tightening. The number of washers used is then calculated as a function of the desired tightening stress and is identical on each screw, in order to apply a uniform tightening stress over the entire stack.

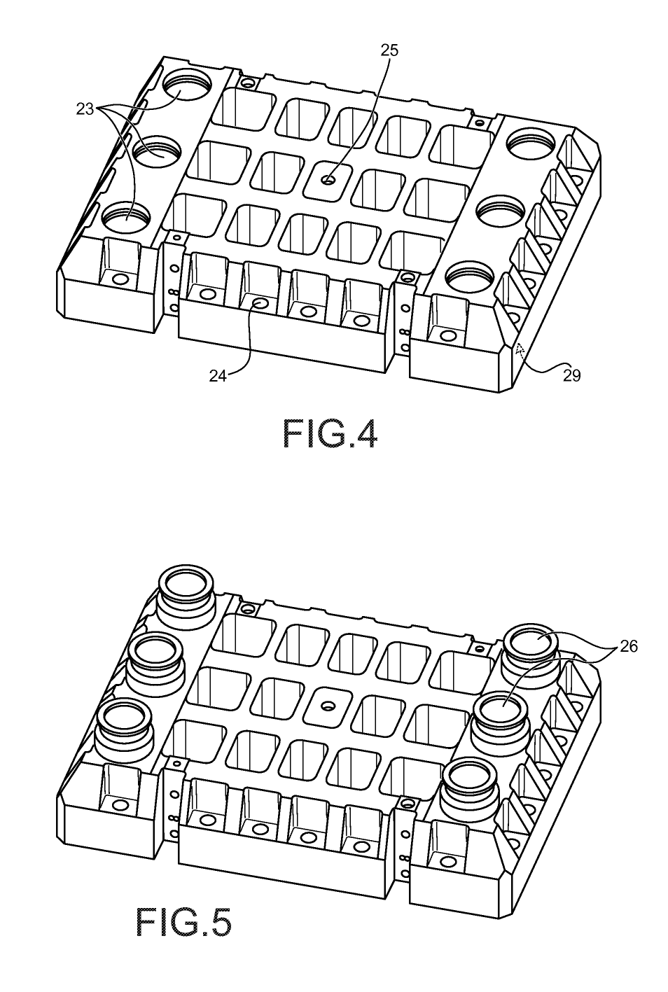

FIG. 4 shows a more detailed view of such an upper tightening clamp. In general, the tightening clamps can be made up of an electrically conducting material, the principle being that, aside from the central conductor 25, the entire upper surface, i.e. opposite the tightening surface and the side surfaces of each tightening clamp, is at least covered with an electrically insulating material or is made from an electrically insulating material.

To be able to cover the supply and discharge holes 23, the electrically insulating material used must also be compatible with the use of reactive gases, e.g. hydrogen at the anode, air or oxygen at the cathode, and with water, whether cooling water or the water generated by the chemical reaction implemented in the stack of the fuel cell. As a result, it is provided to do without extensions, since the tightening clamp, the component material of which is not necessarily compatible with the aforementioned fluids, is insulated from said fluids by the deposition of electrically insulating material in the various ducts. Therefore, the tightening clamps are multifunctional and also perform the function of supplying the stack with fluid.

Moreover, the fact that the electrically insulating deposition material is compatible with the fluids used prevents the electrically conducting material making up the tightening clamps, when such is the case, from performing that function.

The electrically insulating material, deposited on the tightening clamp, must also have stable physico-chemical properties relative to the operating temperatures of the applications considered for the fuel cell. Such a material, simultaneously electrically insulating, compatible with the supply fluids, and stable at the operating temperatures, can constitute a particularly thin deposition, in the vicinity of a few tenths of millimeters, and can for example be a fluorinated resin.

In reference to FIG. 5, connectors 26 are used placed in the openings referenced 23 in FIG. 4, which emerge on the upper surface of the tightening clamp. The connectors 26 provide the interface between the stack and the different supply and discharge installations of the fractionating fluids of the fuel cell. These connectors 26 advantageously replace the extensions, mentioned in reference to FIG. 2 and used in the devices according to the prior art. Indeed, these connectors 26 are less bulky, easier to use and design inasmuch as they are simply screwed into the part opposite the tightening clamp tightening surface, without passing through the entire thickness thereof, unlike the extensions described relative to FIG. 2.

The component material of the connectors 26 can, for example, be a composite polymer material, which must be compatible with the use of reactive gases and with water. It must also ensure the electrical insulation of the stack relative to the connections between the tightening clamps and the various fluid supply and discharge means for the fuel cell assembly.

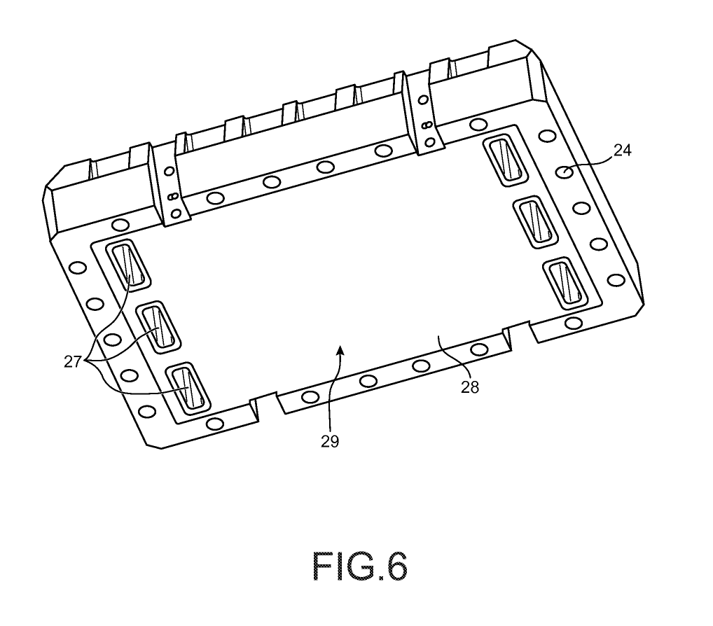

FIG. 6 shows the bottom of a tightening clamp according to the invention and, in particular, a metal deposition 28 placed on the central part of the lower surface 29, which serves as tightening surface and is placed opposite the last separating plate of the stack of elementary cells of the fuel cell. In other words, the metal deposition 28 and the insulating joints of the openings 27 occupy the part of the tightening surface 29 that is in contact with the last plate of the stack. Such a conducting deposition replaces the use of a current collector and has the same surface area as the opposite separating plate to ensure optimal electrical contact. Such an electrically conducting deposition can be made up of a metal material, e.g. silver, and can have a very small thickness, in the vicinity of a few tens of microns. On the other hand, collectors 27, three on each side, corresponding to the supply and discharge openings 23 (FIG. 4), are electrically insulated, i.e. they are covered with a deposition of insulating material. Likewise, on the entire rest of the tightening surface 29 of this multifunctional clamp, in particular the edges, is a deposition of electrically insulating material. Such an electrically insulating material must be stable at the operating temperatures of the fuel cell. FIG. 6 also shows the side openings 24 intended for the passage of the tightening ties of the stack.

The tightening clamp according to the invention is therefore multifunctional because it ensures the electrical insulation of the ducts, the transmission of the electrical current generated towards the outside of the stack, the circulation of the different operating fluids and, of course, using ties, the tightening of the stack of the fuel cell assembly.

1-5. (canceled)

6. A multifunctional single-piece tightening clamp for a fuel cell intended to ensure, via a tightening surface (29), the stack of component elements of the fuel cell, said stack having an end surface having both predetermined electrically conducting areas and predetermined electrically insulating areas,
characterized in that the lower surface of the tightening clamp is covered with an electrically insulating material over the predetermined areas corresponding to the insulated areas of the end surface of the stack, and is made up of a conducting material on a conducting surface (28) of said tightening surface (29), the conducting surface (28) corresponding to the non-insulated areas of the end surface of the stack, and in that supply and discharge openings (23) are covered with a material tolerating the use of the reactive gases used and water, used during operation of the fuel cell.

7. The tightening clamp according to claim 6, characterized in that the material covering the supply and discharge openings (23) is electrically insulating.

8. The tightening clamp according to claim 7, characterized in that it is completed by connectors (26) screwed into the supply and discharge orifices (23).

9. The tightening clamp according to claim 6, characterized in that the insulating material is a fluorinated resin.

10. The tightening clamp according to claim 6, characterized in that the electrically conducting material is silver.
